(19) United States
(12) Patent Application Publication
(10) Pub. No.: US 2025/0354849 A1
(43) Pub. Date: Nov. 20, 2025

(54) Fuel Tank Level Sensor Device

(71) Applicants: Amber Kloth, Medford, WI (US); Chad Kloth, Medford, WI (US)

(72) Inventors: Amber Kloth, Medford, WI (US); Chad Kloth, Medford, WI (US)

(21) Appl. No.: 18/665,933

(22) Filed: May 16, 2024

(51) Int. Cl. G01F 23/00; F17C 13/02

(52) U.S. Cl. CPC G01F 23/0007; F17C 13/02; F17C 2250/0408

(57) ABSTRACT

A fuel tank level sensor device for remotely monitoring the fuel level of a fuel tank includes an electronic thermostat that is visible to occupants of a dwelling and a personal electronic device carried by one of the occupants of the dwelling. A fuel tank gauge is attachable to a fuel tank which is located outdoors thereby facilitating the fuel tank gauge to read the level of fuel in the fuel tank. A communication unit is integrated into the fuel tank gauge which is in remote communication with the thermostat to enable the occupants of the dwelling to read the fuel level of the fuel tank. The communication unit is in remote communication with the personal electronic device to enable the occupant carrying the personal electronic device to read the fuel level of the fuel tank from any location.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to fuel sensor devices and more particularly pertains to a new fuel sensor device for remotely monitoring the level of fuel in a fuel tank. The device includes a fuel tank gauge that is attachable to fuel tank and a communication unit integrated into the fuel tank gauge that is in remote communication with a thermostat located within a dwelling the is serviced by the fuel tank and in remote communication with a personal electronic device. In this way occupants of the dwelling can remotely monitor the fuel level of the fuel tank.

### (2) Description of Related Art Including Information Disclosed Under 37 CFR 1.97 and 1.98

The prior art relates to fuel sensor devices including a variety of fuel tank level sensing devices that each at least includes a fuel level gauge that is attachable to a fuel tank and which each at least includes a single channel of wireless communication for broadcasting a fuel level sensed by the fuel level gauge to a remote electronic device. In no instance does the prior art disclose a fuel tank level sensing device that includes a fuel tank gauge that is attachable to a fuel tank and a communication unit which has a pair of communication channels which are each in wireless communication with a respective one of an electronic thermostat in a dwelling serviced by the fuel tank and a personal electronic device for remotely monitoring the fuel level of the fuel tank.

### (h) BRIEF SUMMARY OF THE INVENTION

An embodiment of the disclosure meets the needs presented above by generally comprising an electronic thermostat that is visible to occupants of a dwelling and a personal electronic device carried by one of the occupants of the dwelling. A fuel tank gauge is attachable to a fuel tank which is located outdoors thereby facilitating the fuel tank gauge to read the level of fuel in the fuel tank. A communication unit is integrated into the fuel tank gauge which is in remote communication with the thermostat to enable the occupants of the dwelling to read the fuel level of the fuel tank. The communication unit is in remote communication with the personal electronic device to enable the occupant carrying the personal electronic device to read the fuel level of the fuel tank from any location.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a fuel tank level sensor device according to an embodiment of the disclosure.

FIG. 2 is a top view of an embodiment of the disclosure.

FIG. 3 is a right side view of an embodiment of the disclosure.

FIG. 4 is a perspective in-use view of an embodiment of the disclosure.

FIG. 5 is a schematic view of an embodiment of the disclosure.

FIG. 6 is a perspective view of an alternative embodiment of the disclosure.

FIG. 7 is a schematic view of an alternative embodiment of the disclosure.

### (j) DETAILED DESCRIPTION OF THE INVENTION

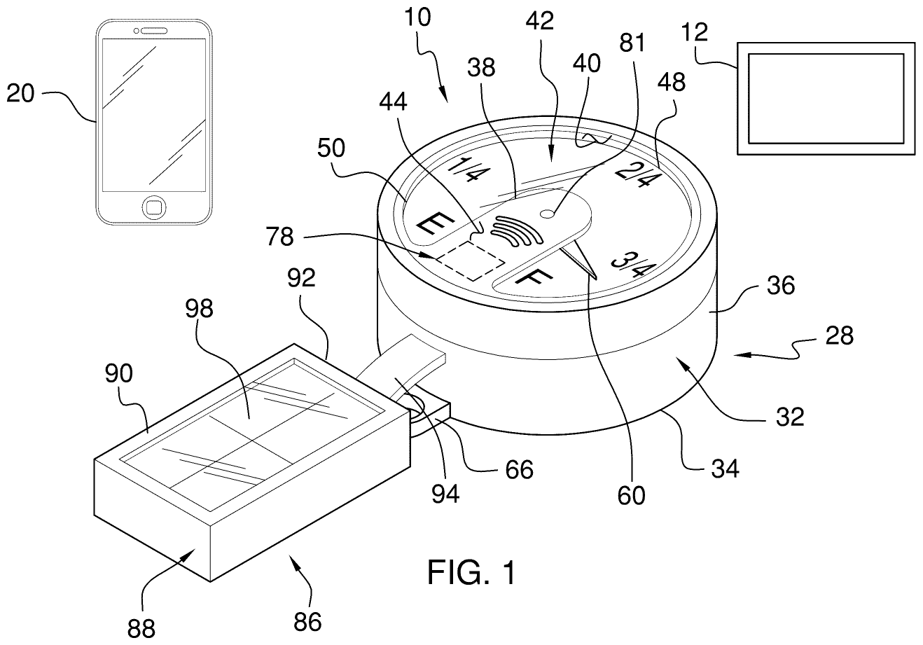

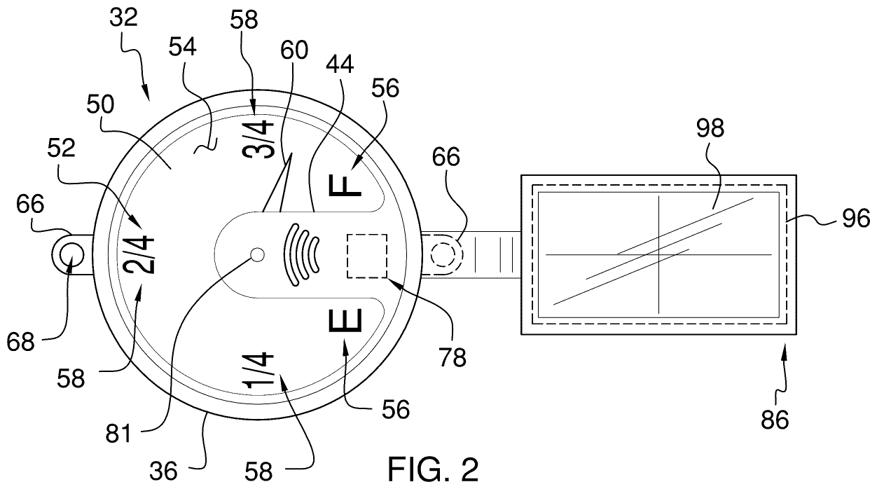

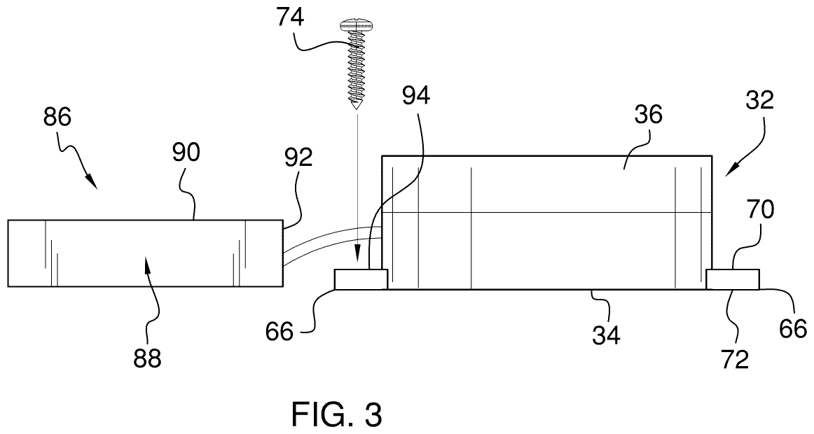

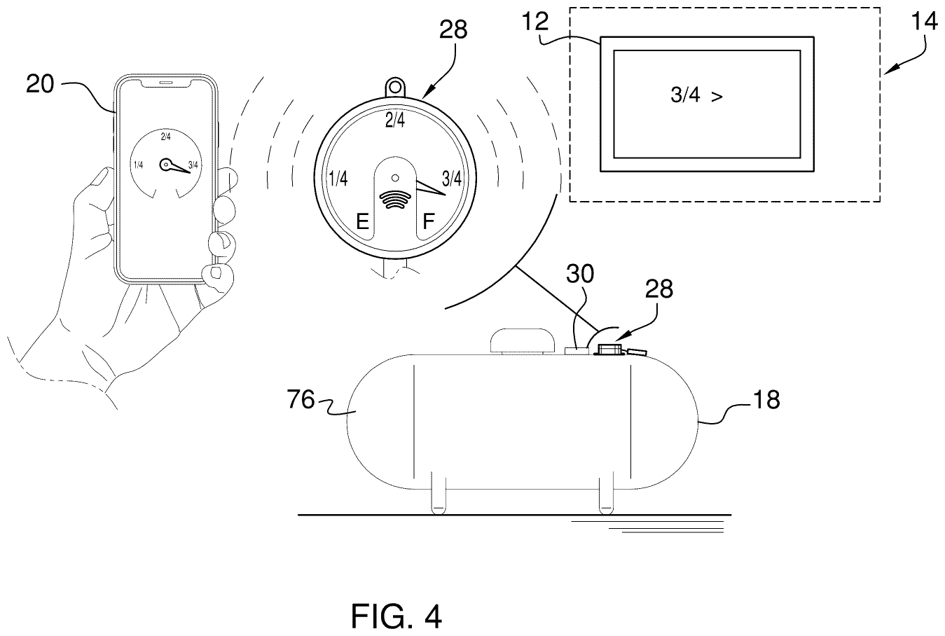

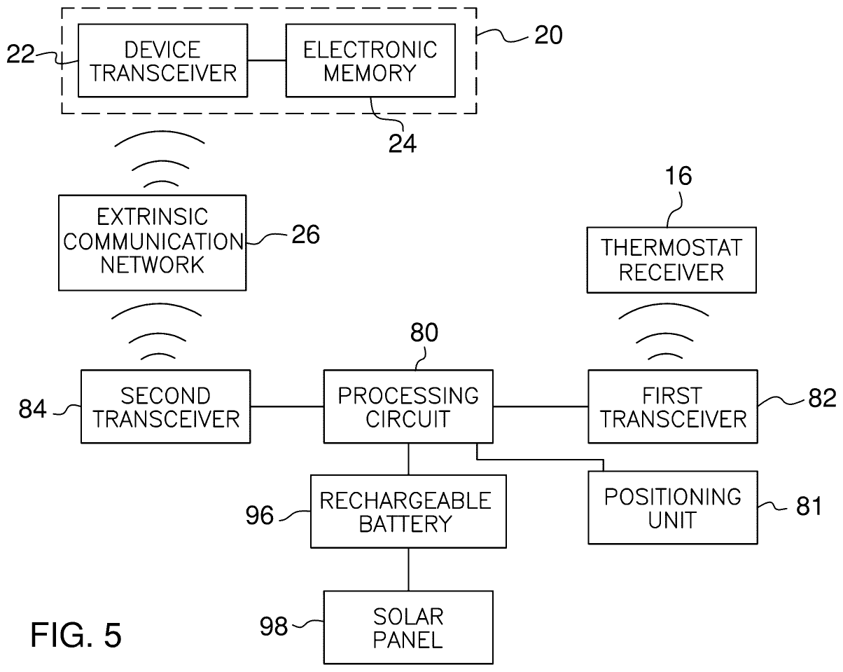

With reference now to the drawings, and in particular to FIGS. 1 through 7 thereof, a new fuel sensor device embodying the principles and concepts of an embodiment of the disclosure and generally designated by the reference numeral 10 will be described.

As best illustrated in FIGS. 1 through 7, the fuel tank level sensor device 10 generally comprises an electronic thermostat 12 that is positionable within a dwelling 14 such that the electronic thermostat 12 is visible to occupants of the dwelling 14. The electronic thermostat 12 is in communication with a heating and cooling system of the dwelling 14 for controlling operational parameters of the heating and cooling system. Additionally, the electronic thermostat 12 has a thermostat transceiver 16 that is integrated into the electronic thermostat 12. The thermostat transceiver 16 may comprise a radio frequency transceiver or the like and the thermostat transceiver 16 may employ Bluetooth communication protocols. Furthermore, the dwelling 14 may be a house or other type of dwelling that has a gas fired heating system and a fuel tank 18 that is located outdoors which services the gas fired heating system.

A personal electronic device 20 is included which is carried by one of the occupants of the dwelling 14. The personal electronic device 20 includes a device transceiver 22 and an electronic memory 24 which stores a database comprising a temperature reading program and the device transceiver 22 is in wireless communication with an extrinsic communication network 26. Furthermore, the device transceiver 22 may comprise a radio frequency transceiver or the like and the extrinsic communication network 26 may comprise the internet, a cellular phone network or any other type of wireless communication network that enables global communication for the personal electronic device 20. Additionally, the personal electronic device 20 may comprise a smart phone or other similar type of electronic device.

A fuel tank gauge 28 is provided and the fuel tank gauge 28 is attachable to the fuel tank 18 which is located outdoors. The fuel tank gauge 28 is in fluid communication with an existing fuel level gauge 30 on the fuel tank 18 thereby facilitating the fuel tank gauge 28 to read the level of fuel in the fuel tank 18. Additionally, the fuel tank gauge 28 has a housing 32 which has a basal wall 34 and a perimeter wall 36 extending upwardly from the basal wall 34. The perimeter wall 36 is continuously arcuate about a center point of the basal wall 34 such that the housing 32 has a cylindrical shape. The fuel tank gauge 28 may be electrically coupled to the existing fuel level gauge 30 with a communication wire or the fuel tank gauge 28 may be fluidly coupled to the existing fuel level gauge 30 with a gas line.

The housing 32 has a peninsula 38 which extends from an inwardly facing surface 40 of the perimeter wall 36 toward a middle of an opening 42 defined by the perimeter wall 36. The peninsula 38 has a top surface 44 which lies on a plane that is oriented parallel to the basal wall 34 and the peninsula 38 is aligned with a top edge 46 of the perimeter wall 36. The fuel tank gauge 28 has a lens 48 which is attached to the top edge 46 of the perimeter wall 36 such that the lens 48 closes the opening 42 defined by the perimeter wall 36. Furthermore, the lens 48 is comprised of a translucent material, including but not being limited to glass or plastic, to pass light through the lens 48 to facilitate an interior of the housing 32 to be visible.

The fuel tank gauge 28 has a fuel level panel 50 which is spaced below the peninsula 38 and which lies on a plane that is oriented parallel to the basal wall 34. The fuel level panel 50 has indicia 52 that is applied to an upper surface 54 of the fuel level panel 50. The indicia 52 comprise the letters 56 “E” and “F” and fractional numbers 58 including “¼” and “½” and “¾”. Furthermore, the letters 56 visually indicate whether the fuel tank 18 is empty or full, respectively, and the fractional numbers 58 visually indicate a level of the fuel in the fuel tank 18 between empty and full. The fuel tank gauge 28 includes a needle 60 that is pivotally attached to a bottom surface 62 of the peninsula 38 at a point which is located adjacent to a distal end 64 of the peninsula 38. The needle 60 is movable between the letters 56 “E” and “F” to indicate the level of the fuel in the fuel tank 18.

The fuel tank gauge 28 has a pair of mounting tabs 66 each extending laterally away from the perimeter wall 36 of the housing 32. Additionally, each of the pair of mounting tabs 66 is aligned with the basal wall 34 of the housing 32. Each of the pair of mounting tabs 66 has a hole 68 extending through a top surface 70 and a bottom surface 72 of the mounting tabs 66. Additionally, the hole 68 in each of the pair of mounting tabs 66 accommodates a fastener 74 for securing the housing 32 to an outer wall 76 of the fuel tank 18.

A communication unit 78 is provided and the communication unit 78 is integrated into the fuel tank gauge 28. The communication unit 78 has a first communication channel which is in remote communication with the thermostat 12 thereby enabling the communication unit 78 to broadcast the fuel level sensed by the fuel tank gauge 28 to the thermostat 12. In this way the communication unit 78 enables the occupants of the dwelling 14 to read the fuel level of the fuel tank 18 without having to leave the dwelling 14. The electronic thermostat 12 may comprise an electronic thermostat of any conventional design that would commonly be employed with residential heating and cooling systems. The communication unit 78 has a second communication channel which is in remote communication with the personal electronic device 20 thereby enabling the communication unit 78 to broadcast the fuel level sensed by the fuel tank gauge 28 to the personal electronic device 20. In this way the communication unit 78 enables the occupant carrying the personal electronic device 20 to read the fuel level of the fuel tank 18 from any location.

The communication unit 78 comprises a processing circuit 80 that is integrated into the housing 32. The processing circuit 80 is electrically coupled to a positioning unit 81 of the needle 60 of the fuel tank gauge 28 thereby enabling the processing circuit 80 to detect the fuel level in the fuel tank 18. The communication unit 78 includes a first transceiver 82 that is integrated into the housing 32 and the first transceiver 82 is electrically coupled to the processing circuit 80. The first transceiver 82 defines the first communication channel and the first transceiver 82 is in wireless communication with the thermostat transceiver 16 thereby enabling the first transceiver 82 to broadcast the fuel level in the fuel tank 18 to the thermostat transceiver 16. Additionally, the first transceiver 82 may comprise a radio frequency transceiver or the like and the first transceiver 82 may employ Bluetooth communication protocols.

The communication unit 78 includes a second transceiver 84 that is integrated into the housing 32 and the second transceiver 84 is electrically coupled to the processing circuit 80. The second transceiver 84 defines the second communication channel. Additionally, the second transceiver 84 is in wireless communication with the extrinsic communication network 26 thereby enabling the second transceiver 84 to be in wireless communication with the device transceiver 22. In this way the second transceiver 84 can broadcast the fuel level in the fuel tank 18 to the device transceiver 22. The second transceiver 84 may comprise a radio frequency transceiver or the like and the second transceiver 84 may employ a WPAN signal to enable to second transceiver 84 to be wirelessly connected to a wireless internet router, for example, or other means of wireless communication with the extrinsic communication network 26.

A power supply 86 is attached to the fuel tank gauge 28 and the power supply 86 is electrically coupled to the communication unit 78. The power supply 86 comprises a battery housing 88 that has a topmost wall 90 and a front wall 92. The power supply 86 includes a strap 94 that is coupled between the perimeter wall 36 of the housing 32 of the fuel tank gauge 28 and the front wall 92 of the battery housing 88 thereby attaching the battery housing 88 to the housing 32 of the fuel tank gauge 28. The power supply 86 includes a rechargeable battery 96 which is positioned within the battery housing 88 and the rechargeable battery 96 is electrically coupled to the processing circuit 80. The power supply 86 includes a solar panel 98 that is attached to the topmost wall 90 of the battery housing 88 such that the solar panel 98 is exposed to sunlight. Furthermore, the solar panel 98 is electrically coupled to the rechargeable battery 96 for charging the rechargeable battery 96.

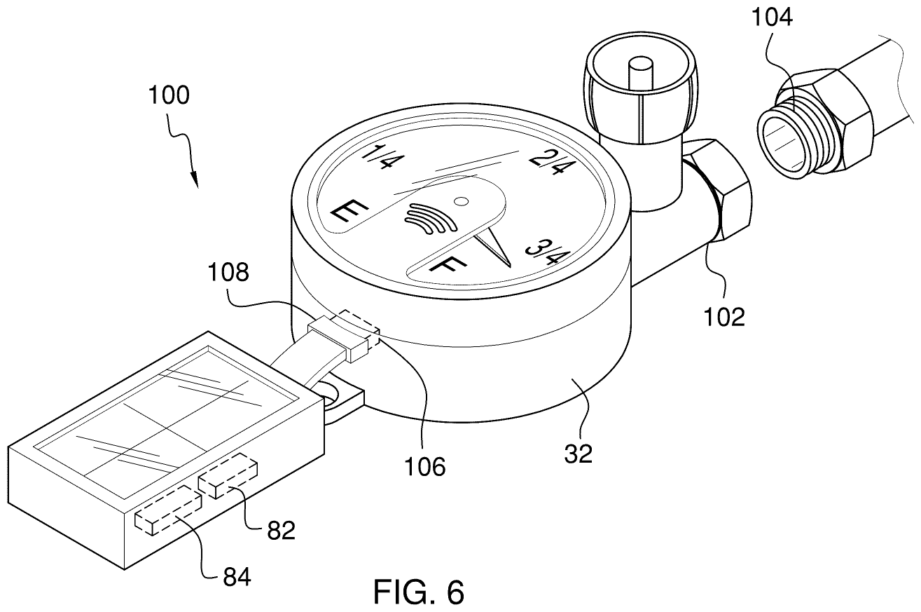

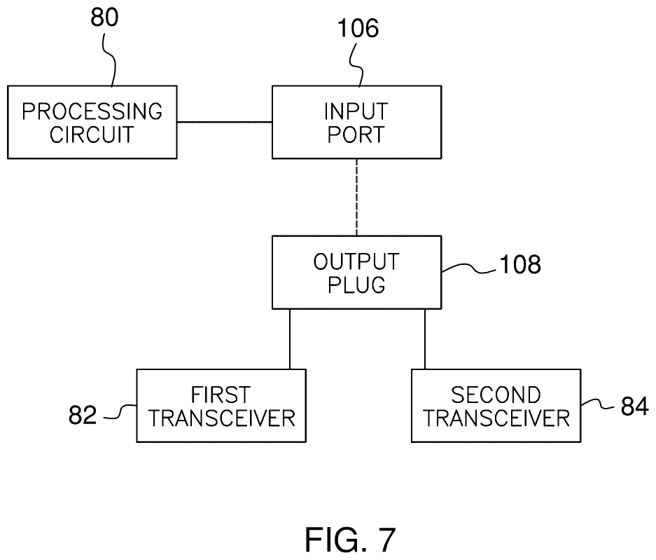

In an alternative embodiment 100 shown in FIGS. 6 and 7, the housing 32 includes a fitting 102 which is attached to an extends laterally away from the perimeter wall 36 of the housing 32. The fitting 102 is in fluid communication with the positioning unit 81 of the needle 60 of the fuel tank gauge 28. Additionally, the fitting 102 is fluidly attachable to a fuel hose 104 of the fuel tank 18 to enable the positioning unit 81 of the needle 60 to position the needle 60 at a point which indicates the fuel level of the fuel tank 18.

Continuing in the alternative embodiment 100, the communication unit 78 includes an input port 106 which is recessed into the perimeter wall 36 of the housing 32 of the fuel tank gauge 28 and the input port 106 is electrically coupled to the processing circuit 80. The power supply 86 includes an output plug 108 which is attached to the strap 94 and the output plug 108 is electrically coupled to the rechargeable battery 96. Furthermore, the output plug 108 is electrically matable to the input port 106 thereby enabling the rechargeable battery 96 to be electrically coupled to the processing circuit 80. Each of the first transceiver 82 and the second transceiver 84 are positioned in the battery housing 88 and each of the first transceiver 82 and the second transceiver 84 is electrically coupled to the output plug 108. In this way each of the first transceiver 82 and the second transceiver 84 can be electrically coupled to the processing circuit 80 when the output plug 108 is electrically mated to the input port 106.

In use, the first transceiver 82 broadcasts the fuel level to the thermostat transceiver 16 thereby enabling the occupants of the dwelling 14 to read the fuel level in the fuel tank 18 without having to go outdoors. In this way the occupants can avoid having to go outdoors during inclement weather, for example, in order to read the fuel level in the fuel tank 18. Furthermore, the occupants can employ the personal electronic device 20 to read the fuel level in the fuel tank 18. In this way the occupants can monitor the fuel level in the fuel tank 18 in the event that the dwelling 14 is a vacation home for the occupants, for example, such that the dwelling 14 might be unoccupied for extended periods of time. In this way the occupants can remotely monitor the fuel level in the fuel tank 18 to ensure that the fuel tank 18 is refilled with fuel before the fuel tank 18 is empty.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fuel tank level sensor device for sensing the level of fuel in a fuel tank and broadcasting level information to a remotely located personal electronic device, said device comprising:
an electronic thermostat being positionable within a dwelling wherein said electronic thermostat is configured to be visible to occupants of said dwelling, said electronic thermostat being in communication with a heating and cooling system of said dwelling for controlling operational parameters of said heating and cooling system;
a personal electronic device being configured to be carried by one of the occupants of said dwelling;
a fuel tank gauge being attachable to a fuel tank which is located outdoors, said fuel tank gauge being in communication with an existing fuel level gauge on said fuel tank thereby facilitating said fuel tank gauge to read the level of fuel in said fuel tank; and
a communication unit being integrated into said fuel tank gauge, said communication unit having a first communication channel being in remote communication with said thermostat thereby enabling said communication unit to broadcast the fuel level sensed by said fuel tank gauge to said thermostat wherein said communication unit is configured to enable the occupants of said dwelling to read the fuel level of said fuel tank without having to leave said dwelling, said communication unit having a second communication channel being in remote communication with said personal electronic device thereby enabling said communication unit to broadcast the fuel level sensed by said fuel tank gauge to said personal electronic device wherein said communication unit is configured to enable the occupant carrying said personal electronic device to read the fuel level of said fuel tank from any location.

2. The device according to claim 1, wherein:
said fuel tank gauge has a housing which has a basal wall and a perimeter wall extending upwardly from said basal wall;
said perimeter wall is continuously arcuate about a center point of said basal wall such that said housing has a cylindrical shape;
housing has a peninsula which extends from an inwardly facing surface of said perimeter wall toward a middle of an opening defined by said perimeter wall;
said peninsula has a top surface which lies on a plane which is oriented parallel to said basal wall;
said peninsula is aligned with a top edge of said perimeter wall;
said fuel tank gauge has a lens which is attached to said top edge of said perimeter wall such that said lens closes said opening defined by said perimeter wall;
said lens is comprised of a translucent material wherein said lens is configured to pass light through said lens to facilitate an interior of said housing to be visible;
said fuel tank gauge has a fuel level panel being spaced below said peninsula and lying on a plane being oriented parallel to said basal wall;
said fuel level panel has indicia being applied to an upper surface of said fuel level panel;
said indicia comprise the letters “E” and “F” and fractional numbers including “¼” and “½” and “¾” wherein said letters are configured to visually indicate whether said fuel tank is empty or full, respectively, and said fractional numbers are configured to visually indicate a level of the fuel in said fuel tank between empty and full;
said fuel tank gauge includes a needle being pivotally attached to a bottom surface of said peninsula at a point being located adjacent to a distal end of said peninsula;
said needle is movable between said letters “E” and “F” wherein said needle is configured to indicate the level of the fuel in said fuel tank;
said fuel tank gauge has a pair of mounting tabs each extending laterally away from said perimeter wall of said housing;
each of said pair of mounting tabs is aligned with said basal wall of said housing; and
each of said pair of mounting tabs has a hole extending through a top surface and a bottom surface of said mounting tabs to accommodate a fastener for securing said housing to an outer wall of said fuel tank.

3. The device according to claim 1, wherein:
said electronic thermostat has a thermostat transceiver being integrated into said electronic thermostat;
said fuel tank gauge includes a housing and a needle being movably disposed in said housing;
said communication unit includes a processing circuit being integrated into said housing;
said processing circuit is electrically coupled to a positioning unit of said needle of said fuel tank gauge thereby enabling said processing circuit to detect the fuel level in said fuel tank;
said communication unit includes a first transceiver being integrated into said housing;
said first transceiver being electrically coupled to said processing circuit;
said first transceiver defines said first communication channel; and
said first transceiver is in wireless communication with said thermostat transceiver thereby enabling said first transceiver to broadcast the fuel level in said fuel tank to said thermostat transceiver.

4. The device according to claim 3, wherein;
said personal electronic device includes a device transceiver and an electronic memory which stores a database comprising a temperature reading program;
said device transceiver is in wireless communication with an extrinsic communication network;
said communication unit includes a second transceiver being integrated into said housing;
said second transceiver is electrically coupled to said processing circuit;
said second transceiver defines said second communication channel; and
said second transceiver is in wireless communication with said extrinsic communication network thereby enabling said second transceiver to be in wireless communication with said device transceiver thereby enabling said second transceiver to broadcast the fuel level in said fuel tank to said device transceiver.

5. The device according to claim 1, wherein:
said fuel tank gauge includes a housing which has a perimeter wall;
said communication unit includes a processing circuit;
said device includes a power supply being attached to said fuel tank gauge;
said power supply is electrically coupled to said communication unit; and
said power supply comprises:
a battery housing having a topmost wall and a front wall;
a strap being coupled between said perimeter wall of said housing of said fuel tank gauge and said front wall of said battery housing thereby attaching said battery housing to said housing of said fuel tank gauge;
a rechargeable battery being positioned within said battery housing, said rechargeable battery being electrically coupled to said processing circuit; and
a solar panel being attached to said topmost wall of said battery housing wherein said solar panel is configured to be exposed to sunlight, said solar panel being electrically coupled to said rechargeable battery for charging said rechargeable battery.

6. A fuel tank level sensor device for sensing the level of fuel in a fuel tank and broadcasting level information to a remotely located personal electronic device, said device comprising:
an electronic thermostat being positionable within a dwelling wherein said electronic thermostat is configured to be visible to occupants of said dwelling, said electronic thermostat being in communication with a heating and cooling system of said dwelling for controlling operational parameters of said heating and cooling system, said electronic thermostat having a thermostat transceiver being integrated into said electronic thermostat;
a personal electronic device being configured to be carried by one of the occupants of said dwelling, said personal electronic device including a device transceiver and an electronic memory which stores a database comprising a temperature reading program, said device transceiver being in wireless communication with an extrinsic communication network;
a fuel tank gauge being attachable to a fuel tank which is located outdoors, said fuel tank gauge being in fluid communication with an existing fuel level gauge on said fuel tank thereby facilitating said fuel tank gauge to read the level of fuel in said fuel tank, said fuel tank gauge having a housing which has a basal wall and a perimeter wall extending upwardly from said basal wall, said perimeter wall being continuously arcuate about a center point of said basal wall such that said housing has a cylindrical shape, housing having a peninsula which extends from an inwardly facing surface of said perimeter wall toward a middle of an opening defined by said perimeter wall, said peninsula having a top surface which lies on a plane being oriented parallel to said basal wall, said peninsula being aligned with a top edge of said perimeter wall, said fuel tank gauge having a lens being attached to said top edge of said perimeter wall such that said lens closes said opening defined by said perimeter wall, said lens being comprised of a translucent material wherein said lens is configured to pass light through said lens to facilitate an interior of said housing to be visible, said fuel tank gauge having a fuel level panel being spaced below said peninsula and lying on a plane being oriented parallel to said basal wall, said fuel level panel having indicia being applied to an upper surface of said fuel level panel, said indicia comprising the letters “E” and “F” and fractional numbers including “¼” and “½” and “¾” wherein said letters are configured to visually indicate whether said fuel tank is empty or full, respectively, and said fractional numbers are configured to visually indicate a level of the fuel in said fuel tank between empty and full, said fuel tank gauge including a needle being pivotally attached to a bottom surface of said peninsula at a point being located adjacent to a distal end of said peninsula, said needle being movable between said letters “E” and “F” wherein said needle is configured to indicate the level of the fuel in said fuel tank, said fuel tank gauge having a pair of mounting tabs each extending laterally away from said perimeter wall of said housing, each of said pair of mounting tabs being aligned with said basal wall of said housing, each of said pair of mounting tabs having a hole extending through a top surface and a bottom surface of said mounting tabs to accommodate a fastener for securing said housing to an outer wall of said fuel tank;
a communication unit being integrated into said fuel tank gauge, said communication unit having a first communication channel being in remote communication with said thermostat thereby enabling said communication unit to broadcast the fuel level sensed by said fuel tank gauge to said thermostat wherein said communication unit is configured to enable the occupants of said dwelling to read the fuel level of said fuel tank without having to leave said dwelling, said communication unit having a second communication channel being in remote communication with said personal electronic device thereby enabling said communication unit to broadcast the fuel level sensed by said fuel tank gauge to said personal electronic device wherein said communication unit is configured to enable the occupant carrying said personal electronic device to read the fuel level of said fuel tank from any location, said communication unit comprising:
a processing circuit being integrated into said housing, said processing circuit being electrically coupled to a positioning unit of said needle of said fuel tank gauge thereby enabling said processing circuit to detect the fuel level in said fuel tank;
a first transceiver being integrated into said housing, said first transceiver being electrically coupled to said processing circuit, said first transceiver defining said first communication channel, said first transceiver being in wireless communication with said thermostat transceiver thereby enabling said first transceiver to broadcast the fuel level in said fuel tank to said thermostat transceiver; and
a second transceiver being integrated into said housing, said second transceiver being electrically coupled to said processing circuit, said second transceiver defining said second communication channel, said second transceiver being in wireless communication with said extrinsic communication network thereby enabling said second transceiver to be in wireless communication with said device transceiver thereby enabling said second transceiver to broadcast the fuel level in said fuel tank to said device transceiver; and
a power supply being attached to said fuel tank gauge, said power supply being electrically coupled to said communication unit, said power supply comprising:
a battery housing having a topmost wall and a front wall;
a strap being coupled between said perimeter wall of said housing of said fuel tank gauge and said front wall of said battery housing thereby attaching said battery housing to said housing of said fuel tank gauge;
a rechargeable battery being positioned within said battery housing, said rechargeable battery being electrically coupled to said processing circuit; and
a solar panel being attached to said topmost wall of said battery housing wherein said solar panel is configured to be exposed to sunlight, said solar panel being electrically coupled to said rechargeable battery for charging said rechargeable battery.

7. The device according to claim 6, wherein:
said device includes a fitting being attached to an extending laterally away from said perimeter wall of said housing;
said fitting is in fluid communication with said positioning unit of said needle of said fuel tank gauge; and
said fitting is fluidly attachable to a fuel hose of said fuel tank wherein said fitting is configured to enable said positioning unit of said needle to position said needle at a point which indicates the fuel level of said fuel tank.

8. The device according to claim 6, wherein:
said communication unit includes an input port being recessed into said perimeter wall of said housing of said fuel tank gauge;
said input port is electrically coupled to said processing circuit;
said power supply includes an output plug being attached to said strap;
said output plug is electrically coupled to said rechargeable battery;
said output plug is electrically matable to said input port thereby enabling said rechargeable battery to be electrically coupled to said processing circuit;
each of said first transceiver and said second transceiver are positioned in said battery housing; and
each of said first transceiver and said second transceiver is electrically coupled to said output plug thereby enabling each of said first transceiver and said second transceiver to be electrically coupled to said processing circuit when said output plug is electrically mated to said input port.
